(19) United States
(12) Patent Application Publication
(10) Pub. No.: US 2006/0197784 A1
(43) Pub. Date: Sep. 7, 2006

(54) Instruction plate and signage using photo luminescent porcelain enamel

(76) Inventor: Duk Shin Lee, Seoul (KR)

Correspondence Address: PARK LAW FIRM, 3255 WILSHIRE BLVD, SUITE 1110, LOS ANGELES, CA, 90010, US

(21) Appl. No.: 10/553,486

(22) PCT Filed: Apr. 14, 2004
(86) PCT No.: PCT/KR04/00865

§ 371 Date: Oct. 17, 2005

(30) Foreign Application Priority Data
Apr. 15, 2003 (KR) 20-2003-0011643

(51) Int. Cl. G09G 5/10

(52) U.S. Cl. 345/690

(57) ABSTRACT

The present invention relates to a guide plate and instruction plate using photo luminescent porcelain enamel that includes an improved guide plate and instruction plate implemented in such a manner that aluminum, steel, copper, alloy plate, etc., after removing of anti-rust oil (lubricant), are preprocessed for an easier adherence, and a primary coat enamel and a necessary coat enamel are processed, and a ground surface is processed with non-photo luminescent porcelain enamel; and character, number, symbol, graphic, image, pattern, etc. of the guide plate and instruction plate are molded with photo porcelain enamel.

### TECHNICAL FIELD

The present invention relates to a photo luminescent porcelain enamel for an instruction plate and a signage in which various activity guidelines, a facility/utility use instruction plate, an emergency escape facility instruction plate, various instruction plates, an electric guide/subway map and indoor and outdoor advertisement boards are made using a photo luminescent porcelain wherein the above plates are provided for an emergency situation such as fire, natural disaster, accident, etc.

### BACKGROUND ART

The present invention is directed to fabricating various facility/utility use guide plates, emergency rescue request guide plate, escape guide plate, safety rule guide plate, emergency exit instruction plate, other instruction plates, electric train rail/subway map, etc. in such a manner that a porcelain enamel is used or mixed with photo luminescent pigment, and a mixture is enameled to aluminium, steel, stainless, copper and alloy plate.

Since the conventional products are printed (enameled) on a sticker paper, aluminum plate, steel plate, acryl plate, etc. or are integrally formed thereon, the conventional products may be burned our or it is impossible to easily read an instruction text in a dark environment. Therefore, the conventional products may not be used in the case of an emergency situation such as fire.

### BRIEF DESCRIPTION OF THE DRAWINGS

FIG. 1 is a view illustrating the construction that a character part is formed of a photo luminescent porcelain enamel (photo luminescent enamel), and a background surface is formed of a non-photo luminescent porcelain enamel (non-photo luminescent coloring oil) in a guide plate and an instruction plate according to the present invention; and

FIG. 2 is a view illustrating a state that a background surface is coated with a non-photo luminescent coloring oil or a photo luminescent pigment (if necessary, light emitting pigment may be added) and a photo luminescent enamel and then a line map is printed and processed according to the present invention.

### DISCLOSURE OF THE INVENTION

Accordingly, it is an object of the present invention to provide a photo luminescent porcelain enamel for an instruction plate and a signage capable of achieving an inherent function and enhancing a fire resistance, a heat resistance, a water (or moisture) proof and a durability for thereby maximizing effects in such a manner that a photo luminescent enamel (if necessary, light emitting pigment may be added) is used or mixed with enamel, and a mixture is enameled to aluminum, steel, copper and alloy plate for thereby fabricating various facility/utility use instruction plates, emergency rescue guide plate, shelter information plate, safety guide plate, emergency exit plate, other instruction plates, electric rail train/subway line map, indoor and outdoor advertisement boards, etc.

It is another object of the present invention to provide a photo luminescent porcelain enamel for an instruction plate and a signage capable of decreasing a cost based on a permanent use, and achieving an easier escape or necessary instruction during a fire or emergency situation, and saving energy.

To achieve the above objects, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent porcelain enamel; and character, number, symbol, graphic, image, pattern, etc. of the guide plate and instruction plate are processed with photo luminescent porcelain enamel.

To achieve the above objects, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with photo luminescent porcelain enamel; and character, number, symbol, graphic, image, pattern, etc. of the guide plate and instruction plate are processed with non-photo luminescent porcelain enamel.

To achieve the above objects, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent coloring oil (or enamel material); and character, number, symbol, graphic, image, pattern, etc. of the guide plate and instruction plate are molded with photo luminescent enamel.

To achieve the above objects, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with photo luminescent enamel; and character, number, symbol, graphic, image, pattern, etc. of the guide plate and instruction plate are processed with non-photo luminescent coloring oil (or enamel material).

To achieve the above objects, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with photo luminescent enamel; and character, number, symbol, graphic, image, pattern, etc. of the guide plate and instruction plate are processed using a heat transfer printing paper.

To achieve the above objects, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent coloring oil (or enamel); and character, number, symbol, graphic, image, pattern, etc. of the guide plate and instruction plate are molded using a heat transfer printing paper.

### BEST MODE FOR CARRYING OUT THE INVENTION

The preferred embodiments of the present invention will be described with reference to the accompanying drawings. In the following descriptions, when it is judged that the known function or construction may take the gist of the present invention unclear, the detailed descriptions of the same will be omitted.

The preferred embodiments of the present invention will be described with reference to the accompanying drawings.

According to a first embodiment of the present invention, there is provided a

A guide plate and instruction plate using photo luminescent porcelain enamel, comprising:

an improved guide plate and instruction plate implemented in such a manner that aluminum, steel, copper, alloy plate, etc., after removing of anti-rust oil (lubricant), are preprocessed for an easier adherence, and primary coat enamel and a secondary coat enamel are processed, and a ground surface is processed with non-photo luminescent porcelain enamel; and character, number, symbol, graphic, image, pattern, etc. of the guide plate and instruction plate are processed with photo luminescent porcelain enamel.

According to a second embodiment of the present invention, there is provided a guide plate and instruction plate 1 using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with photo luminescent porcelain enamel 2; and character, number, symbol, graphic, image, pattern, etc. of the guide plate and instruction plate 1 are processed with non-photo luminescent porcelain enamel 3.

According to a third embodiment of the present invention, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent coloring oil (or enamel material); and character, number, symbol, graphic, image, pattern, etc. of the guide plate and instruction plate are processed with photo luminescent enamel.

According to a fourth embodiment of the present invention, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is character, number, symbol, graphic, image, pattern, etc. of the guide plate and instruction plate are processed with photo luminescent enamel.

According to a fourth embodiment of the present invention, there is provided a guide plate and instruction plate using photo luminescent porcelain enamel, comprising an improved guide plate and instruction plate implemented in such a manner that aluminum, steel, copper, alloy plate etc., after removing of anti-rust oil (lubricant), are preprocessed for an easier adherence, and a primary coat enamel and a secondary coat enamel are processed, and a ground surface is processed with photo luminescent enamel; and character, number, symbol, graphic, image, pattern, etc. of the guide plate and instruction plate are molded with non-photo luminescent coloring oil (or enamel material).

According to a fifth embodiment of the present invention, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and secondary coat enamel are processed, and a ground surface is processed with photo luminescent enamel; and character, number, symbol, graphic, image, pattern, etc. of the guide plate and instruction plate are molded using a heat transfer printing paper.

According to sixth embodiment of the present invention, there is provided a guide plate and instruction plate using photo luminescent porcelain enamel, comprising an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent coloring oil (or enamel); and character, number, symbol, graphic, image, pattern, etc. of the guide plate and instruction plate are molded using a heat transfer printing paper.

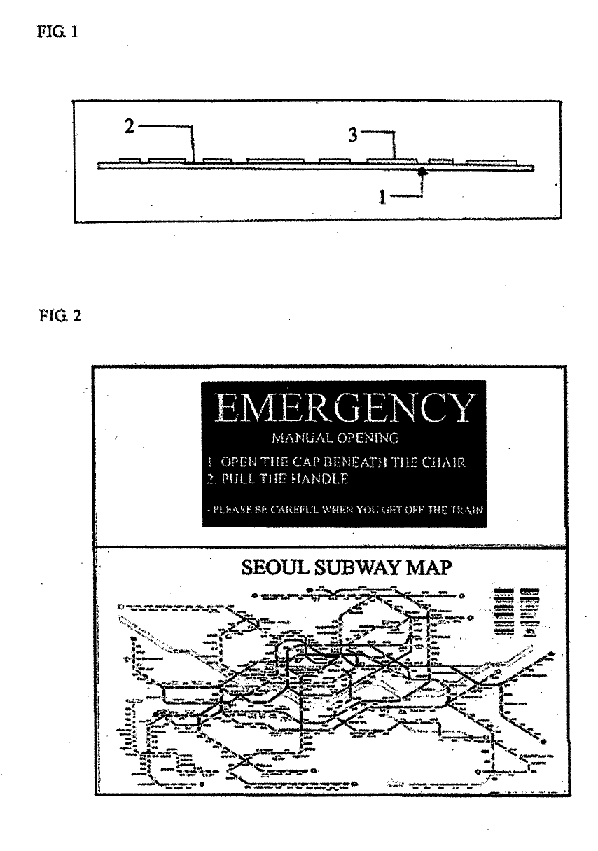

As shown in FIGS. 1 and 2, a photo luminescent pigment mixed with a photo luminescent material (if necessary, light emitting pigment is added) and a porcelain enamel at a certain mixing ratio is defatted and preprocessed for an easier adherence using brush, screen, spray, etc. having a desired shape of character, number, symbol, graphic, image, pattern, picture, etc. based on the purpose and place of use. The thusly-processed enamel is coated on a metallic plate on which lower and upper suspension oils are burned and stuck thereon. In another way, character, number, symbol, graphic image, picture, etc. are coated with non-photo light coloring oils (or enamel material), and the remaining whole parts or part of the same are coated with a porcelain enamel mixed with photo luminescent enamel material.

In addition, character, number, symbol, graphic, image, pattern, picture, etc. are printed and processed on a background surface coated with a porcelain enamel mixed with photo luminescent enamel material using a heat transfer printing paper as shown in the line map of FIG. 2. At this time, the processing temperature is adjusted based on heat resistant property of a metallic plate. In the case of steel plate, it is about 800° C.˜920° C., in the case of aluminum, it is below about 560° C., provided that the processing is achieved within a range that the function of photo luminescent enamel material is not diminished. As described above, since photo luminescent enamel (if necessary, light emitting pigment material is added) is added into only a desired character, number, symbol, graphic, image, pattern, picture, etc., so that the character, number, symbol, graphic, image, pattern, picture, etc. are visually recognizable in darkness. On the contrary, in the case that the whole portions or a part of the character, number, symbol, graphic, image, pattern, picture, etc. are coated with non-photo luminescent coloring oil (or pigment material), since the portions of the photo luminescent pigment material generate light, they are also visually recognizable.

The guide plate and instruction plate 1 according to the present invention may be easily attached using adhesive, piece bolt, installation frame, etc. In addition, mass production is achieved in the present invention, so that guide plate and instruction plate, guide plate, line map, advertisement board, etc. may be provided at a very competitive price wherein the above plates have large demand.

### INDUSTRIAL APPLICABILITY

As described above, in the case that an emergency situation such as fire, natural disaster, accident, etc. in building, underground facility, subway, train/subway, elevator, aircraft and ship occurs, people can easily read an instruction guide and open an exit door and escape or can take a proper measurement for the emergency situation in such a manner that various guide plates, emergency rescue request guide plate, shelter guide plate, instruction plate, line map, etc. are fabricated using photo luminescent porcelain enamel according to the present invention. In addition, people can properly escape, reading a shelter guide instruction in a high-rise building and apartment. In addition, people can use a fire extinguishing device or extinguisher, reading an instruction for use. In the case that people is stuck in a closed dark space such as in elevator, people can easily read a rescue request instruction for thereby calling for an emergency rescue staff.

In addition, when the present invention is adapted to an indoor or outdoor advertisement board, an energy saving effect is excellent. In particular, in the interior of an electric train or subway, the electric train/subway line map instruction of the photo luminescent porcelain enamel can help passenger to recognize the emergency exit and escape to the outside, so that it is possible to safely guide the passenger for thereby achieving an excellent safety effect.

In the case of the photo luminescent porcelain enamel, a mass product is possible, so that price can be competitive. It has an excellent function, fire resistance, water and moisture proof and durability. It may be used permanently. The effects are excellent. In particular, when fabricating it, since it is possible to control luminance based on the amount of use of photo luminescent pigment (if necessary, light emitting pigment, may be added), the unit cost may be adjusted based on the characteristic of use of the same.

In addition, in the case of a vehicle license number plate, road information plate, resident address plate, etc., light emitting pigment may be added to photo luminescent enamel for thereby maximizing the effects of the same based on excellent function.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A guide plate and instruction plate using photo luminescent porcelain enamel, comprising:
an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent porcelain enamel; and character, number, symbol, graphic, image, pattern, etc. of the guide plate and instruction plate are molded with photo luminescent porcelain enamel.

2. A guide plate and instruction plate using photo luminescent porcelain enamel, comprising:
an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with photo luminescent porcelain enamel; and character, number, symbol, graphic, image, pattern, etc. of the guide plate and instruction plate are molded with non-photo luminescent porcelain enamel.

3. A guide plate and instruction plate using photo luminescent porcelain enamel, comprising:
an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with non-photo luminescent coloring oil (or enamel material); and character, number, symbol, graphic, image, pattern, etc. of the guide plate and instruction plate are processed with photo luminescent enamel.

4. A guide plate and instruction plate using photo luminescent porcelain enamel, comprising:
an improved guide plate and instruction plate implemented in such a manner that aluminum, steel, copper, alloy plate, etc., after removing of anti-rust oil (lubricant), are preprocessed for an easier adherence, and a primary coat enamel and a secondary coat enamel are processed, and a ground surface is processed with photo luminescent enamel; and character, number, symbol, graphic, image, pattern, etc. of the guide plate and instruction plate are processed with non-photo luminescent coloring oil (or enamel material).

5. A guide plate and instruction plate using photo luminescent porcelain enamel, comprising:
an improved guide plate and instruction plate implemented in such a manner that aluminum, steel, copper, alloy plate, etc., after removing of anti-rust oil (lubricant), are preprocessed for an easier adherence, and a primary coat enamel and secondary coat enamel are processed, and a ground surface is processed with photo luminescent enamel; and character, number, symbol, graphic, image, pattern, etc. of the guide plate and instruction plate are processed using a heat transfer printing paper.

6. A guide paper and instruction plate using photo luminescent porcelain enamel, comprising:
an improved guide plate and instruction plate implemented in such a manner that aluminum, steel, copper, alloy plate, etc., after removing of anti-rust oil (lubricant), are preprocessed for an easier adherence, and a primary coat enamel and secondary coat enamel are processed, and a ground surface is processed with non-photo luminescent coloring oil (or enamel); and character, number, symbol, graphic, image, pattern, etc. of the guide plate and instruction plate are processed using a heat transfer printing paper.
